(19) United States
(12) Patent Application Publication
(10) Pub. No.: US 2009/0218003 A1
(43) Pub. Date: Sep. 3, 2009

(54) Method and Device for Manufacturing Content-Filled Bottle

(76) Inventors: Shunzo Miyazaki, Saitama (JP); Yasuhiro Sato, Saitama (JP); Hiroyuki Nakane, Saitama (JP); Akio Watanabe, Gunma (JP); Masaru Kimura, Gunma (JP); Tomoya Oosaka, Gunma (JP)

Correspondence Address: BIRCH STEWART KOLASCH & BIRCH, PO BOX 747, FALLS CHURCH, VA, 22040-0747, US

(21) Appl. No.: 12/226,868

(22) PCT Filed: May 11, 2007
(86) PCT No.: PCT/JP2007/059737

§ 371 Date: Oct. 30, 2008

(30) Foreign Application Priority Data
May 15, 2006 (JP) 2006-135221

(51) Int. Cl. B67C 3/14; B67C 3/24

(52) U.S. Cl. 141/4; 141/114; 141/390; 141/369

(57) ABSTRACT

A method and device for manufacturing a content-filled bottle having an inversion part at its bottom. In producing the bottle, the inversion part is inverted to prevent deformation of a body part caused by a pressure reduction in the bottle, and as a result, inappropriate deformation and buckling of the bottle are prevented, enabling efficient manufacturing of the bottle with high quality. The bottle (3) is held from the outside by an empty-bottle chuck (41) of auxiliary device mounting means in such a way that the bottle (3) is held at its a mouth part (4) by the chuck along the upper surface of a flange part (10) of the bottle (3). Next, an empty-bottle support table (42) on which an assistance device (24) is placed is raised, the assistance device (24) is mounted on a bottom part (7) of the bottle (3), and the bottle (3) is placed on the empty-bottle support table (42). After that, with the empty bottle (3) held positioned by the empty-bottle chuck (41) and the empty-bottle support table (42), the inversion part (12) is projected to the outside of the body part (6) by a push-down member (54) of bottom projecting means. Then, the bottle (3) is filled with contents and sealed by a cap. The inverted part (12) is recessed into the body part (6), and the assistance device (24) is separated from the bottle (3).

### TECHNICAL FIELD

The present invention relates to a method and device for manufacturing a content-filled bottle, and more specifically, to a method for manufacturing a content-filled bottle, in which a liquid substance is filled into the interior of a synthetic resin bottle having an inversion part disposed on a bottom part thereof, and which is capable of causing the inversion part to be inverted between a state in which the inversion part is recessed inwardly along an axial direction of a body part, and a state in which the inversion part projects outwardly from the body part, along with a device for carrying out such a method.

As a content-filled bottle, which accommodates a liquid substance such as a drink or the like therein, for example, a bottle (PET bottle) made by blow forming a polyethylene-telephthalate material has been known. In this type of bottle, for purposes of heat sterilization, the bottle is filled with a drink, which has been heated to a high temperature (e.g., 85° C.), whereupon cooling is performed after an opening of the bottle has been hermetically sealed by a cap. Thus, upon cooling, the interior of the bottle is placed in a reduced pressure state together with a reduction in the volume of the liquid drink. Also at this time, a body portion of the bottle becomes deformed by the reduced pressure inside the bottle, which tends to make the outer appearance of the bottle unfavorable.

Therefore, on such synthetic resin bottles that are intended to be filled with liquid contents at a high temperature, multiple formation of flexible panels on the body part, which evenly absorb the deformation accompanying the internal pressure reduction after filling, is carried out. However, in the case that such panels are provided, the shape of the bottle becomes complicated and the material cost for the bottle increases.

Consequently, it has been known to provide an inversion part capable of being inverted between concave and convex shapes on a bottom part of the bottle, wherein the heated liquid contents are filled in a state in which the inverted part projects outwardly from the bottle, and after the bottle opening is sealed by the cap, the inversion part in a state of projecting outwardly from the body part is recessed inwardly into the body part, when the pressure is reduced as a result of cooling.

In this type of bottle, prior to filling of the liquid contents therein, the inversion part on the bottom of the bottle is pressed out so as to project outwardly from the body part. Next, liquid contents that have been heated to a high temperature are filled into the interior of the bottle in a state in which the inversion part of the bottom part projects outwardly from the body part, and the opening of the bottle is sealed by a cap. Thereafter, when the liquid contents inside the bottle are cooled resulting in a reduced pressure state, the inversion part on the bottom of the bottle, which is in an outwardly projected state, is pressed up and recessed inwardly into the bottle. As a result, the reduced pressure state of the inside pressure is canceled out, whereby reduced pressure deformation of the container body part does not occur. In this manner, the inversion part, which is invertible between concave and convex states, is provided on the bottom of the bottle, wherein assuming the inversion part is made to become inverted during the manufacturing steps of the content-filled bottle, panels for evenly absorbing the aforementioned deformation do not need to be provided on the body part of the bottle, and therefore the degree of freedom in designing the bottle can be enhanced, together with enabling a reduction in material costs for the bottle.

However, in such a bottle which prevents reduced pressure deformation of the body part by concave/convex inversion of the bottom of the bottle, the inversion part on the bottom of the bottle into which contents have been filled beforehand must be made to project outwardly from the body portion, and thus the bottom part of the bottle becomes unstable and it is difficult to transport the bottle in a self-standing state. Therefore, after the inversion part on the bottom of the bottle has been made to project outwardly from the body part, a cylindrically shaped auxiliary tool having a ground portion on which the bottle bottom is stabilized is installed, whereby the projecting part on the bottom portion is accommodated within the auxiliary tool. Thus, by enabling the bottle to stand on its own through means of the auxiliary tool, transporting of the bottle in a stable manner is conceivable.

However, during the manufacturing steps for the content-filled bottle, a problem results in that, in addition to the fact that the process of concave/convex inversion of the bottle bottom portion must be carried out multiple times, in the case of installing the auxiliary tool as described above, a process for installing the auxiliary tool must also be provided, whereby the number of process steps increases and efficiency is deteriorated. Moreover, in particular, because the body and bottom parts in this type of synthetic resin bottle are thin-walled, the integrity thereof for maintaining the shape of the bottle is comparatively weak, and there is a concern that along with increasing the number of process steps, when an excessive load is applied to the bottle, inappropriate deformation and buckling may occur, whereby the product quality of the bottle becomes degraded.

### DISCLOSURE OF THE INVENTION

The present invention has been devised taking into account the aforementioned problems and has the object of providing a method and device by which a content-filled bottle can be manufactured with good efficiency and high product quality, wherein, during manufacturing of the content-filled bottle in which reduced pressure deformation of the body portion is prevented through concave/convex inversion of a bottom part thereof, inappropriate deformation or buckling of the content-filled bottle is prevented.

For accomplishing the concerned objects, the present invention provides a method for manufacturing a content-filled bottle, in which liquid contents are hermetically sealed in a synthetic resin bottle comprising a hollowed body part, an opening provided on an upper end of the body part and capable of being fitted with a cap thereon, a bottom part that closes a bottom end of the body part, and an inversion part provided within a portion of the bottom part, which is capable of undergoing inversion between a state of being recessed inwardly into the body part along an axial direction of the body part, and a state of projecting outwardly from the body part, the method being characterized by:

an auxiliary tool mounting step by which a cylindrical auxiliary tool, formed with a shape such that a portion thereof capable of being mounted on the bottom part of the bottle and corresponding to the inversion part is opened, and which is capable of accommodating the inversion part in the state of projecting outwardly from the body part, is mounted onto a bottom part outer periphery of a non-content-filled empty bottle under a condition in which the inversion part is recessed inwardly into the body part;

a bottom part projecting step in which the inversion part on the bottom part of the empty bottle, on which the auxiliary tool has been mounted by the auxiliary tool mounting step, is made to project outwardly from the body part;

a content filling step in which liquid contents are filled into the interior of the bottle having the inversion part thereof projecting outwardly from the body part by means of the bottom part projecting step;

a sealing step in which a cap is fitted onto the opening of the filled bottle, the interior of which has been filled with liquid contents by the content filling step, for sealing the bottle;

a bottom part recessing step by which the inversion part that projects outwardly from the filled bottle in which the cap has been fitted by the sealing step is recessed inwardly into the body part; and

an auxiliary tool separating step in which the auxiliary tool is separated from the filled bottle in which the inversion part has become recessed inwardly into the body part by the bottom part recessing step,

wherein the auxiliary tool mounting step further comprises an empty bottle retaining step for retaining the empty bottle by gripping the opening from an outer side thereof along an upper surface of a flange that is formed on an outer periphery of the opening of the empty bottle, and an empty bottle loading step in which an empty bottle support table that raisably supports the empty bottle onto which the auxiliary tool has been mounted is raised, whereby the auxiliary tool is installed onto the bottom part of the empty bottle that is retained by the retaining step, and wherein the empty bottle is loaded onto the empty bottle support table through the auxiliary tool, and

wherein the bottom part projecting step further comprises a bottom part downward pressing step in which a rod shaped pushdown member is lowered in an axial direction from the opening of the empty bottle, which has been loaded onto the empty bottle support table by the empty bottle loading step, and is inserted into the interior of the empty bottle, whereby the inversion part in an inwardly recessed state is pressed downwardly by an end of the pushdown member from the inside of the empty bottle so as to project outwardly from the body part, and a pushdown member retracting step in which the pushdown member is raised and retracted from the inside of the empty bottle after the inversion part has been inversely projected by the bottom part downward pressing step.

According to the method of the present invention, the opening is gripped on an upper surface of a flange (so-called support ring) in the empty bottle retaining step of the auxiliary tool mounting step. In addition, in the empty bottle loading step, installation of the auxiliary tool onto the bottom part of the bottle and loading of the bottle onto the top of the empty bottle support table are carried out by raising the empty bottle support table. Accordingly, at the same time that the auxiliary tool is installed, the empty bottle becomes positioned between the upper surface of the flange and the bottom part thereof is positioned above the empty bottle support table.

In addition, by maintaining the above state and by the bottom part downward pressing step of the bottom part projecting step, the rod shaped pushdown member is lowered from the opening of the empty bottle, thereby causing the inversion part to project outwardly. Subsequently, withdrawal of the pushdown member from the empty bottle is carried out by the pushdown member retracting step.

In this manner, according to the present invention, positioning is finalized at the same time that the auxiliary tool is installed. Accordingly, projecting of the inversion part can be linked with and carried out by the pushdown member, and lowering of efficiency accompanying installation of the auxiliary tool can be prevented. In addition, the structure of the apparatus is simplified and equipment costs can be decreased. Furthermore, because the bottom part projecting step can be performed while maintaining high positional accuracy by means of the auxiliary tool mounting step, the positioning at which the pushdown member is pressed down does not suffer from off placement or shifting. Accordingly, damage to the bottom part of the empty bottle can be reliably prevented and a content-filled bottle of high product quality can be manufactured.

Further, when the inversion part of the synthetic resin bottle comprises an inclined portion, which is capable of concave/convex inversion in a symmetrical shape inwardly and/or outwardly of the body part, and a bottom part central portion formed in a region surrounded by the inclined portion, in the bottom part downward pressing step of the bottom part projecting step, the inversion part is pressed downward by the end of the pushdown member along at least an inner peripheral edge of the inclined portion of the inversion part.

When the inversion part of the synthetic resin bottle is inverted, the boundary thereof with the bottom part central portion acts as a hinge. In such a case, by pressing down along the inner peripheral edge of the inclined portion which acts as a hinge, adverse effects are not imparted to the bottom part central portion and the inversion part can be inverted outwardly from the body part with a comparatively small pressing force. The load imposed on the bottom part of the bottle at the time of inversion can be alleviated, and inadvertent deformations can be reliably prevented while enabling the inversion part to be inverted securely. Accordingly, damage to the bottom part of the empty bottle can be reliably prevented and a content-filled bottle of high product quality can be manufactured with good efficiency.

Further, in the bottom part downward pressing step and in the pushdown member retracting step, raising and lowering of the pushdown member is driven through an arm that extends outwardly of the bottle along a vertical direction of the bottle, and which is connected to an upper end of the pushdown member.

Accordingly, a driving mechanism or the like for raising and lowering the pushdown member can be disposed outside of the bottle through the arm. Owing thereto, the driving mechanism or the like is not positioned directly above the opening, and falling of foreign substances (for example, machine oil or the like) from the driving mechanism and incursion thereof from the opening of the bottle can be reliably prevented.

Further, the bottom part recessing step of the present invention includes a filled bottle loading step by which the filled bottle on which the auxiliary tool is installed is loaded onto a filled bottle support table from which a downward position corresponding to the inversion part is open, a shoulder part pressing step by which a shoulder part, which extends to an upper end of the body part from a lower end of an opening of the filled bottle that is loaded onto the filled bottle support table, is pressed so as to prevent upward movement thereof, and a bottom part pushup step in which the inversion part, in a state of projecting outwardly from the body part of the filled bottle, which is prevented from upward movement by the shoulder part pressing step, is pressed upwardly and recessed into the body part by an end of a rod shaped pushup member.

In the bottom part recessing step of the present invention, the filled bottle is loaded onto the filled bottle support table by the filled bottle loading step, and in a state in which the shoulder part of the filled bottle is pressed by the shoulder part pressing step, the inversion part of the filled bottle, in a projected state, is pressed upwardly and recessed inwardly by the bottom part pushup step. In the bottom part pushup step, when an end of the pushup member pushes the bottom part of the filled bottle upward, an upward pressing force is applied in the axial direction of the filled bottle. However, due to the fact that the shoulder part of the filled bottle is pressed upon, the resultant buckling strength of the bottle is sufficiently brought forth, whereby resistance can be provided against the upward pushing force of the pushup member. Owing thereto, when the inversion part is pressed upward, causing the inversion part to be recessed inward, even if a load is applied to the bottle, inappropriate deformation and buckling of the bottle does not occur, and a content-filled bottle that exhibits high product quality can be manufactured.

Furthermore, when the inversion part of the synthetic resin bottle includes an inclined portion, which is capable of concave/convex inversion in a symmetrical shape inwardly and/or outwardly of the body part, and a bottom part central portion formed in a region surrounded by the inclined portion, in the bottom part pushup step of the bottom part recessing step, preferably, the inclined portion and the bottom part central portion of the inversion part are pressed upwardly by the end of the pushup member.

Consequently, in the bottom part pushup step, since the inclined portion and the bottom part central portion are pressed upwardly by the end of the pushup member, inappropriate deformation of the inclined portion and the bottom part central portion is regulated while the inversion part is recessed inwardly into the body part. Owing thereto, the bottom part of the filled bottle can be recessed into a correct shape for the inversion part.

Further, the auxiliary tool separating step of the present invention is characterized by a filled bottle retaining step in which the opening is gripped from the outside along a lower surface of a flange formed on an outer periphery of the opening of the filled bottle, and an auxiliary tool pull down step of coupling to the auxiliary tool, which is installed on the filled bottle retained by the filled bottle retaining step, and pulling the auxiliary tool downward of the filled bottle.

In accordance with the present invention, since the flange of the bottle having a comparatively high strength is retained from below while the auxiliary tool is pulled downward, compared to a case, for example, in which the body part is retained while the auxiliary tool is pulled downward, deformation of the body can be favorably suppressed, and the auxiliary tool can be detached without diminishing the product quality of the bottle.

Further, the present invention provides a device for manufacturing a content-filled bottle, in which liquid contents are hermetically sealed in a synthetic resin bottle comprising a hollowed body part, an opening provided on an upper end of the body part and capable of being fitted with a cap thereon, a bottom part that closes a bottom end of the body part, and an inversion part provided within a portion of the bottom part, which is capable of undergoing inversion between a state of being recessed inwardly into the body part along an axial direction of the body part, and a state of projecting outwardly from the body part, the device being characterized by:

auxiliary tool mounting means for mounting a cylindrical auxiliary tool, formed with a shape such that a portion thereof capable of being mounted on the bottom part of the bottle and corresponding to the inversion part is opened, and which is capable of accommodating the inversion part in a state of projecting outwardly from the body part, onto a bottom part outer periphery of a non-content-filled empty bottle under a condition in which the inversion part is recessed inwardly into the body part;

bottom part projecting means for causing the inversion part on the bottom part of the empty bottle, on which the auxiliary tool has been mounted by the auxiliary tool mounting means, to project outwardly from the body part;

content filling means for filling liquid contents into the interior of the bottle having the inversion part thereof projecting outwardly from the body part by means of the bottom part projecting means;

sealing means for fitting a cap onto the opening of the filled bottle, the interior of which has been filled with liquid contents by the content filling means, for thereby sealing the bottle;

bottom part recessing means for recessing the inversion part, which projects outwardly from the filled bottle on which the cap has been fitted by the sealing means, inwardly into the body part; and

auxiliary tool separating means for separating the auxiliary tool from the filled bottle in which the inversion part has been recessed inwardly into the body part by the bottom part recessing means,

wherein the auxiliary tool mounting means further comprises an empty bottle chuck for gripping the opening from an outer side thereof along an upper surface of a flange that is formed on an outer periphery of the opening of the empty bottle, an empty bottle support table disposed below the empty bottle that is retained by the empty bottle chuck, which is raised with the auxiliary tool loaded thereon whereby the auxiliary tool is installed onto the bottom part of the empty bottle, and which supports the empty bottle for being raised and lowered through the auxiliary tool, and table raising/lowering means for driving raising and lowering of the empty bottle support table, and

wherein the bottom part projecting means further comprises a rod shaped pushdown member, which is capable of being raised and lowered, disposed above an opening of the empty bottle that is retained by the empty bottle chuck, and which is inserted into the interior of the empty bottle from the opening, whereby the inversion part in an inwardly recessed state is pressed downwardly from the inside of the empty bottle so as to project outwardly from the body part, and a pushdown member raising/lowering means for driving raising and lowering of the pushdown member.

In manufacturing of the content-filled bottle by the device of the present invention, first, the auxiliary tool is installed onto the bottom outer periphery of an empty bottle by the auxiliary tool mounting means. Next, the inversion part on the bottom part of the empty bottle is inverted by the bottom part projecting means and made to project outwardly from the body part. In succession, the interior of the bottle is filled with liquid contents by the content filling means, and a cap is fitted onto the opening of the filled bottle by the sealing means for thereby sealing the bottle. In addition, the inversion part that projects downwardly from the filled bottle is pressed and inverted inwardly into the body part, thereby recessing the inversion part, by the bottom part recessing means.

According to the present invention, when the auxiliary tool is mounted onto the bottom outer periphery of the empty bottle by the auxiliary tool mounting means, the opening is gripped along an upper surface of the flange of the empty bottle by the empty bottle chuck provided in the auxiliary tool mounting means. Next, the empty bottle table is raised by the table raising/lowering means, whereby the auxiliary tool loaded onto the empty bottle support table is installed onto the bottom part of the empty bottle. Because the empty bottle chuck abuts against the bottle from the upper surface side of the flange and upward movement of the bottle is regulated, in such a regulated state, solely by raising the empty bottle support table, the auxiliary tool can be mounted onto the bottom part of the empty bottle, whereby installation of the auxiliary tool can be reliably and speedily carried out.

Furthermore, the raised empty bottle support table assumes a state in which the empty bottle is loaded thereon at the time that the auxiliary tool is mounted onto the bottom part of the empty bottle. In this condition, next, the inversion part of the bottom portion of the empty bottle is inversely projected downward by the bottom part projecting means. More specifically, the pushdown member is lowered by the pushdown member raising/lowering means and is inserted into the empty bottle, whereby the end of the pushdown member presses down on the inversion part. At this time, the empty bottle is gripped and placed in a positioned state by the empty bottle chuck and the empty bottle support table of the auxiliary tool mounting means. Owing thereto, the pressing position of the pushdown member, with respect to the inversion part of the bottom part of the empty bottle, is not shifted, and thus damage to the bottom part of the empty bottle can reliably be prevented. In addition, because such proper positioning is completed simultaneously with mounting of the auxiliary tool, the projecting operation of the inversion part, which is performed by the pushdown member, can be carried out quickly in sequence after mounting of the auxiliary tool, lowering of efficiency accompanying mounting of the auxiliary tool can be prevented, and the structure of the apparatus can be simplified together with enabling a reduction in equipment costs.

Further, when the inversion part of the synthetic resin bottle includes an inclined portion, which is capable of concave/convex inversion in a symmetrical shape inwardly and/or outwardly of the body part, and a bottom part central portion formed in a region surrounded by the inclined portion, preferably the pushdown member of the bottom part pushdown means includes an annular convex part on an end thereof, which presses downward along at least an inner peripheral edge of the inclined portion of the inversion part.

When the inversion part of the synthetic resin bottle is inverted, the boundary thereof with the bottom part central portion acts as a hinge. In the present invention, because an annular protrusion-is disposed on the end of the pushdown member of the bottom part pushdown means, the inversion part can be pressed down reliably along an inner peripheral edge of the inclined portion, which acts as a hinge. Consequently, the inversion part can be made to project outwardly from the body part without occurrence of inadvertent deformation to the inversion part, whereas the inversion part can be inverted with a comparatively small pressing force. Accordingly, the load applied to the bottom part when the inversion part is inverted can be reduced, damage to the bottom part of the empty bottle can be reliably prevented, and a content-filled bottle of high product quality can be manufactured with good efficiency.

Further, in the device of the present invention, preferably the pushdown member raising/lowering means is positioned on an upper side of the empty bottle that is retained by the empty bottle chuck, and is connected to the pushdown member through an arm extending directly above the opening of the empty bottle.

Accordingly, a driving mechanism or the like for raising and lowering the pushdown member can be disposed outside of the bottle through the arm. Owing thereto, because the driving mechanism or the like is not positioned directly above the opening, falling of foreign substances (for example, machine oil or the like) from the driving mechanism and incursion thereof from the opening of the bottle can be reliably prevented.

Further, in the device of the present invention, the bottom part recessing means further includes a filled bottle support table having an opening therein open at a downward position corresponding to the inversion part of the filled bottle on which the auxiliary tool is mounted, a shoulder part presser by which a shoulder part, which extends to an upper end of the body part from a lower end of an opening of the filled bottle that is loaded onto the filled bottle support table, is pressed so as to prevent upward movement thereof, a rod shaped pushup member, which is capable of being raised and lowered, and by which the inversion part, in a projected state, is pressed upwardly and recessed into the body part through the opening of the filled bottle support table by an end of the rod shaped pushup member, and a punch raising/lowering means for raising and lowering the pushup member.

According to the present invention, when the inversion part on the bottom part of the filled bottle is recessed inwardly into the body part by the bottom part recessing means, first, the filled bottle is loaded onto the filled bottle support table through the auxiliary tool and the shoulder part is pressed from above by the shoulder part presser. Subsequently, the pushup member is raised by the punch raising/lowering means, and the inversion part, which is in an outwardly projected state from the body part of the filled bottle, is pressed upwardly by the pushup member, which is raised through the opening of the filled bottle support table. Owing thereto, the projected state of the inversion part becomes inverted, whereby the inversion part is recessed inwardly into the body part of the bottle.

When the pushup member pushes the bottom part of the filled bottle upwardly, an upward pressing force is applied in the axial direction of the filled bottle. However, due to the fact that the shoulder part of the filled bottle is pressed upon, and by pressing the body part evenly over a comparatively wide range upwardly of the body part, a resultant buckling strength of the bottle is sufficiently brought forth, whereby resistance can be provided reliably against the upward pressing force of the pushup member. Owing thereto, even if a load is applied by the pressing force of the pushup member to portions apart from the inversion part of the bottle, inappropriate deformation and buckling of the bottle does not occur, and a content-filled bottle that exhibits high product quality can be manufactured.

Further, in the device of the present invention, the inversion part of the synthetic resin bottle preferably includes an inclined portion, which is capable of concave/convex inversion in a symmetrical shape inwardly and/or outwardly of the body part, and a bottom part central portion formed in a region surrounded by the inclined portion, the pushup member of the bottom part recessing means having a pushup abutment part on an end thereof which abuts against the inversion part, wherein the pushup abutment part has a shape corresponding to the bottom part central portion, and also has a shape adapted to circumferentially press at least a part of the inclined portion.

In accordance therewith, the pushup abutment part of the pushup member of the bottom part recessing means initially presses the bottom part central portion upwardly, while the inclined portion, which is also pushed up at the same time, is inverted along the shape of the pushup abutment part. Consequently, inadvertent deformation of the inclined portion and the bottom part central portion can be regulated while the bottom part is pressed upward, and the bottom part of the filled bottle can be recessed with a correct shape for the inversion part. Due to the pushup abutment part having a shape corresponding to the bottom part central portion, the upward pressing force can be applied while being concentrated on the bottom part central portion, and furthermore, by having a shape adapted to circumferentially press at least the inclined portion, inadvertent deformation when the inclined portion is inverted is prevented. Further, at this time, the pushup abutment part may also have a shape corresponding to the inclined portion.

Further, in the device of the present invention, the auxiliary tool separating means further includes a filled bottle chuck for gripping the opening from an outer side thereof along a lower surface of the flange formed on the outer periphery of the opening of the filled bottle, an auxiliary tool coupling member, which is capable of being raised and lowered so as to be coupled to the auxiliary tool that is mounted on the filled bottle retained by the filled bottle chuck, and for pulling down the auxiliary tool downward of the filled bottle, so as to separate the auxiliary tool from the filled bottle, and a coupling member raising and lowering means for driving raising and lowering of the auxiliary tool coupling member.

According to the present invention, the filled bottle is retained by the filled bottle chuck of the auxiliary tool separating means and the auxiliary tool coupling member is coupled to the auxiliary tool. Subsequently, in accordance with lowering of the auxiliary tool coupling member by means of the coupling member raising and lowering means, the auxiliary tool is made to separate from the filled bottle. When the auxiliary tool coupling member is lowered and the auxiliary tool is pulled downward, because the filled bottle is retained by the filled bottle chuck from beneath the flange, which exhibits a comparatively high strength, compared to a case, for example, in which the body part is retained while the auxiliary tool is pulled downward, deformation of the body can be favorably suppressed, and the auxiliary tool can be detached without adversely affecting the product quality of the bottle.

At this time, more specifically, the auxiliary tool preferably includes an annular latching groove on an outer peripheral surface thereof, and the auxiliary tool coupling member includes a projection that engages with the latching groove of the auxiliary tool, the projection latching with the latching groove when the auxiliary tool is raised by the coupling member raising and lowering means, and the latched state between the projection and the latching groove being maintained when the coupling member raising and lowering means is lowered, thereby separating the auxiliary tool from the filled bottle. Consequently, the auxiliary tool has a simple structure and can be separated quickly from the filled bottle.

Further, in the present invention, the auxiliary tool preferably is equipped with engaging pawls on a circumferential wall thereof, which are elastically attachable/detachable with a recess formed in the body part of the bottle. In accordance therewith, in the auxiliary tool, the engaging pawls engage reliably in the recess of the body part of the bottle, and the mounted condition of the auxiliary tool on the bottle can be reliably maintained without becoming detached therefrom. Furthermore, since the engaging pawls elastically engage with the recess of the bottle body part, engagement in the recess of the body bottle part can be smoothly performed upon mounting, and separation of the auxiliary tool can also be smoothly carried out by the auxiliary tool separating means.

### BRIEF DESCRIPTION OF THE DRAWINGS

FIG. 1 is a plan view showing in outline the structure of an empty bottle processing apparatus in the device of the embodiment of the present invention;

FIG. 2 is a plan view showing in outline the structure of a filled bottle processing apparatus in the device of the present embodiment;

FIG. 3 is a cross sectional explanatory view of a synthetic resin bottle adopted for use in the present embodiment;

FIG. 4 is a perspective view of an auxiliary tool;

FIG. 5 is an explanatory vertical cross sectional view of the auxiliary tool;

FIG. 6 is an explanatory cross sectional view showing an auxiliary tool mounting means and a bottom part projecting means of the empty bottle processing apparatus;

FIG. 7 is an explanatory plan view of an empty bottle chuck;

FIG. 8 is an explanatory view showing a retained state of an empty bottle;

FIG. 9 is an explanatory cross sectional view showing a bottom part recessing means and an auxiliary tool separating means of a filled bottle processing apparatus;

FIG. 10 is an explanatory view showing a retained state of a filled bottle in the bottom part recessing means;

FIG. 11 is an explanatory plan view of a shoulder part presser;

FIG. 12 is an explanatory view showing a retained state of a filled bottle in the auxiliary tool separating means;

FIG. 13 is an explanatory view typically illustrating an auxiliary tool mounting process and a bottom part projecting process performed by the device of the present embodiment;

FIG. 14 is an explanatory view typically showing a bottom part recessing process performed by the device of the present embodiment; and

FIG. 15 is an explanatory view typically showing an auxiliary tool separating process performed by the device of the present embodiment.

### BEST MODE FOR CARRYING OUT THE INVENTION

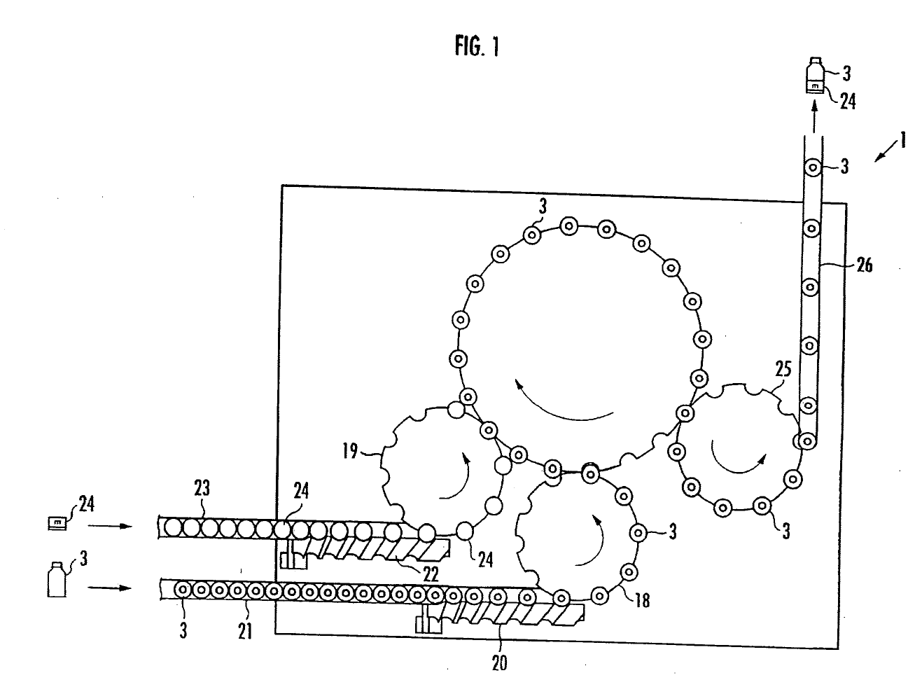

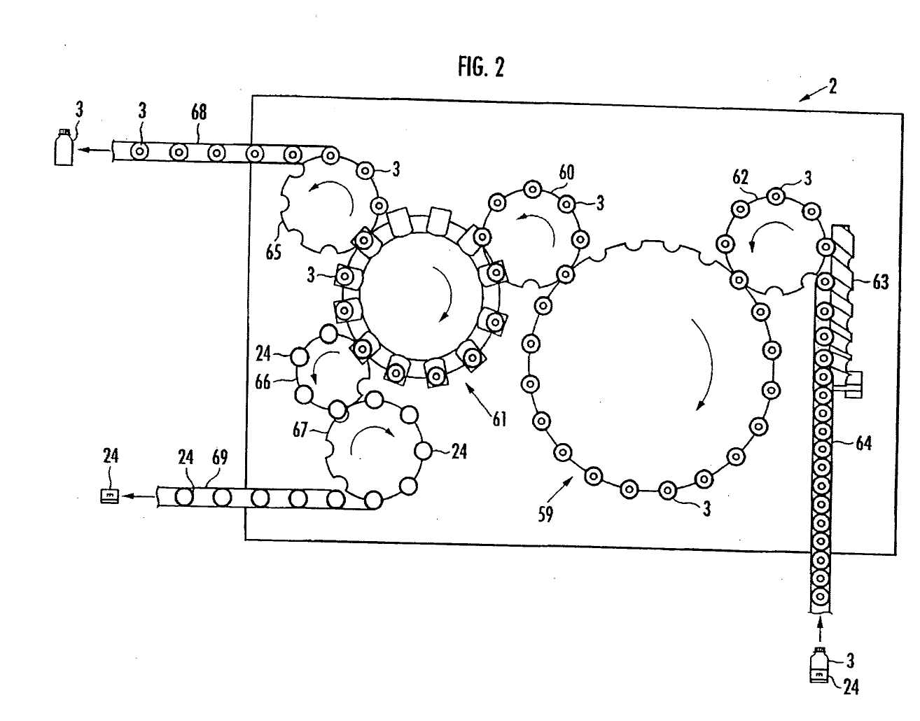

An embodiment of the present invention shall be explained with reference to the drawings. The device of the present invention is utilized for manufacturing a content-filled bottle, which is filled with contents such as a beverage or the like, wherein portions thereof are made up of an empty bottle processing apparatus 1 as shown in FIG. 1, and a filled bottle processing apparatus 2 as shown in FIG. 2. Although not shown, a filler (content filling means) of a known configuration for filling of contents, and a capper (sealing means) of a known configuration for sealing bottles by means of caps, are disposed between the empty bottle processing apparatus 1 and the filled bottle processing apparatus 2.

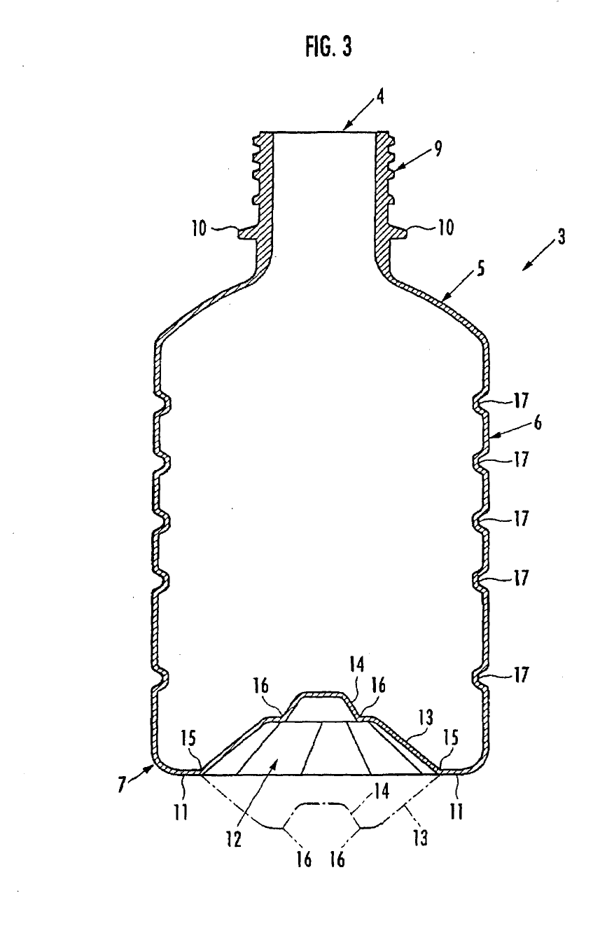

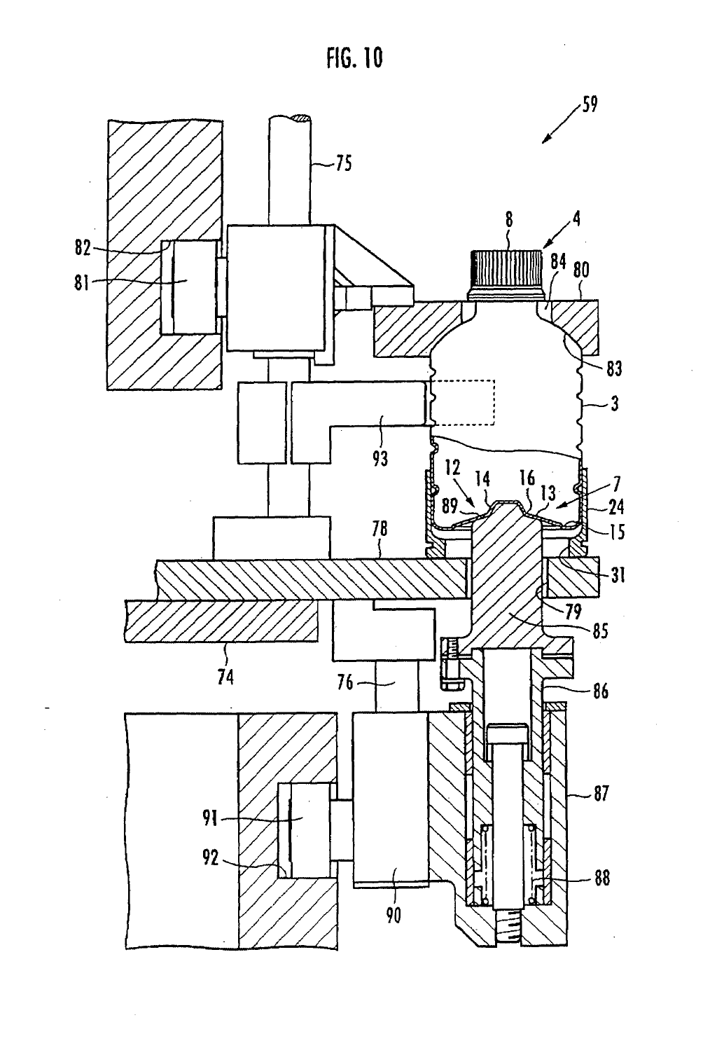

A bottle 3, which is placed in the empty bottle processing apparatus 1, comprises a polyethylene-telephthalate resin (PET) bottle made by blow formation. As shown in FIG. 3, the bottle 3 is made up of an opening 4 which opens upwardly, a hollow body part 6 connected through an expanded diameter shoulder part 5 from a lower end of the opening 4, and a bottom part 7, which closes (blocks) the lower end of the body part 6. A threaded portion 9 for threaded attachment of a cap 8 thereon (see FIG. 10) is formed on the opening 4, and a flange 10, which expands outwardly around the outer circumference thereof, is formed at a lower part of the threaded portion 9. A ring-shaped ground portion 11 is formed on an outer circumferential side of the bottom part 7, and an inversion part 12, which is recessed inwardly into the body part 6, is formed inside of the ground portion 11. The inversion part 12 comprises an inclined portion 13, which is convex/concave invertible in symmetrical shapes inwardly of the body part 6 and/or outwardly of the body part 6, and an inward projecting portion 14 formed in a bottom central part surrounded by the inclined portion 13. A first hinge section 15 is disposed in an annular shape at the outer circumferential edge of the inclined portion 13, and a second hinge section 16 is disposed in an annular shape at the inner circumferential edge (i.e., at the border with the inward projecting portion 14) of the inclined portion 13. The inclined portion 13 is made so as to be convex/concave invertible by bending about the first hinge section 15 and the second hinge section 16. On the other hand, the inward projecting portion 14 is moved up and down upon inversion of the inclined portion 13 but the shape thereof is retained. Further, in order to preserve strength, a plurality of beads 17 are formed on the body part 6.

In the description of the present embodiment, while the container is unfilled as shown in FIG. 3, the bottle 3 with the opening 4 thereof in an open state is referred to as an empty bottle, whereas as shown in FIG. 10, a sealed state thereof, in which the interior of the container is filled and the opening 4 is sealed by a cap 8, is referred to as a filled bottle.

First, an explanation shall be given concerning the empty bottle processing apparatus 1. As shown in FIG. 1, on the upstream side of the empty bottle processing apparatus 1, an empty bottle injection turret 18 and an auxiliary tool injection turret 19 are provided. The empty bottle injection turret 18 is connected to a terminal end of an empty bottle injection conduit 21 equipped with a screw conveyor 20, which inputs empty bottles 3 to the empty bottle processing apparatus 1. The auxiliary tool injection turret 19 is connected to a terminal end of an auxiliary tool injection conduit 23 equipped with a screw conveyor 22, which inputs auxiliary tools 24 to the empty bottle processing apparatus 1. Further, on the downstream side of the empty bottle processing apparatus 1, a discharge turret 25 for discharging empty bottles 3 and a discharge conveyor 26 are provided. The discharge conveyor 26 transports empty bottles 3, which have gone through the empty bottle processing apparatus 1, to an unillustrated filler.

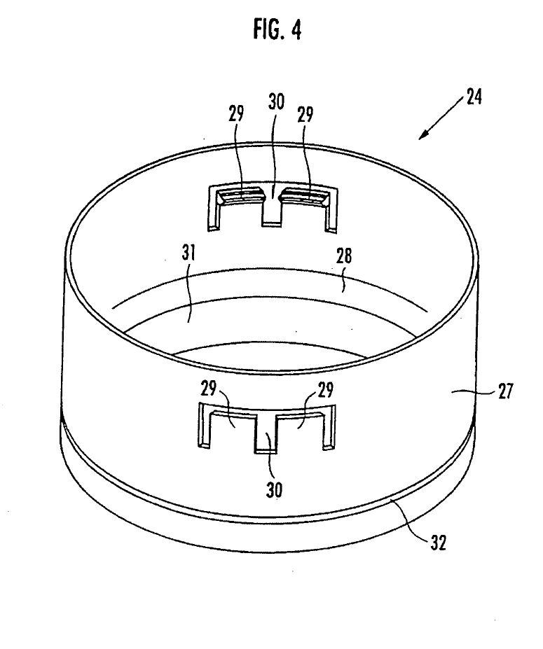

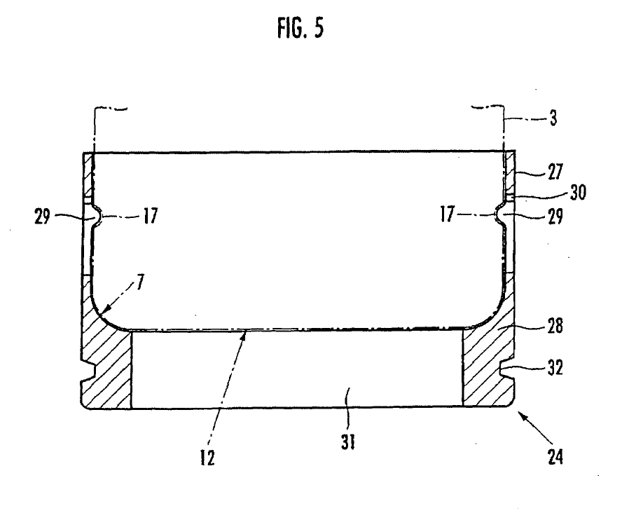

The auxiliary tool 24 is formed in a cylindrical shape from a comparatively hardened synthetic resin material, and is installed onto the bottle 3 so as to cover the bottom part 7 thereof from a lower end portion of the body part 6 of the bottle 3. As shown in FIGS. 4 and 5, the auxiliary tool 24 is formed by a peripheral wall 27 and a bottom part supporting section 28. Bead engaging pawls 29, which project inwardly and are engageable and detachable with respect to the lowermost positioned beads 17 (recesses) formed in the body part 6, are disposed in the peripheral wall 27 of the auxiliary tool 24. The bead engaging pawls 29 engage elastically within the beads 17 of the bottle 3 through cuts 30. Further, an opening 31 positioned to correspond with the inversion part 12 of the bottle 3 is formed in the bottom part supporting section 28 of the auxiliary tool 24, and an annular engagement groove 32 is formed on the outer circumferential surface thereof. The auxiliary tool 24 of the present embodiment has a cylindrical shape corresponding to the shape of the bottle 3, however, for example, in the case that the bottle is formed with a polygonal prism shape, the auxiliary tool may have a polygonal tubular shape corresponding to the shape of the bottle.

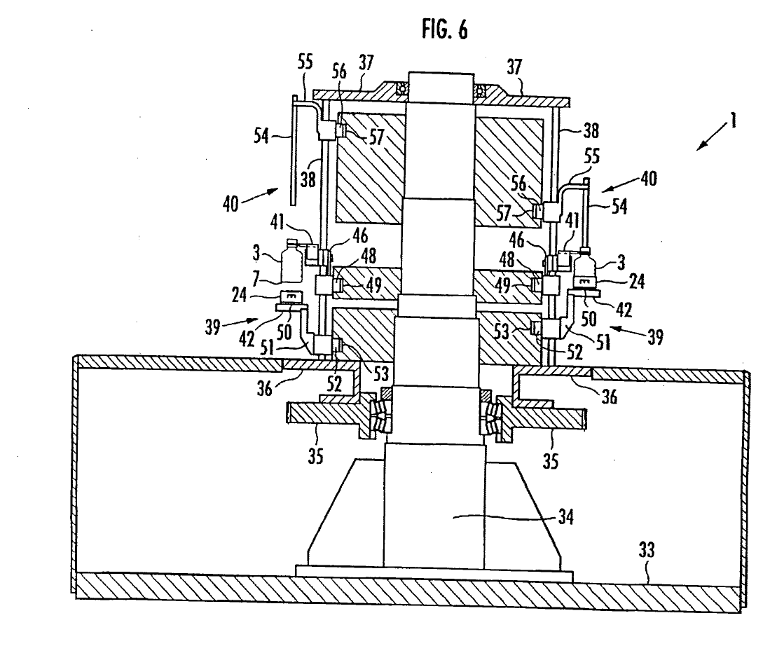

As shown in FIG. 6, the empty bottle processing apparatus 1 is equipped with a support pillar 34 disposed upright on a base 33, a drive gear 35 supported rotatably on the support pillar 34, and a turntable 36 that rotates integrally with the gear 35. Further, a top panel 37 is supported rotatably on an upper end of the support pillar 34, such that the top panel 37 and the turntable 36 are connected together integrally by a plurality of vertically extending guide rods 38. The gear 35 is connected to an unillustrated rotary driving means such as a motor or the like. In addition, the empty bottle processing apparatus 1 comprises plural auxiliary tool mounting means 39 for mounting auxiliary tools 24 onto the empty bottles 3, and a plurality of bottom part projecting means 40, for causing the inversion part 12 of the empty bottles 3 to be inverted and project downwardly.

Each of the auxiliary tool mounting means 39 comprises an empty bottle chuck 41 fixed to and supported by one of the guide rods 38, and an empty bottle support table 42, which is supported while capable of being raised and lowered on the guide rod 38 at a downward position from the empty bottle chuck 41.

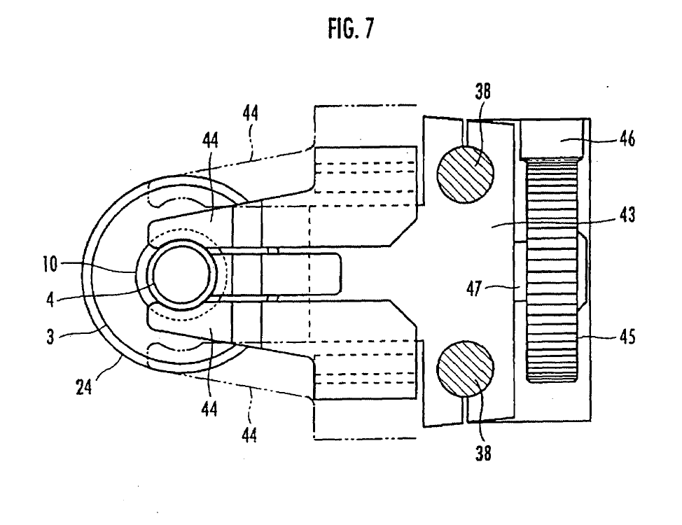

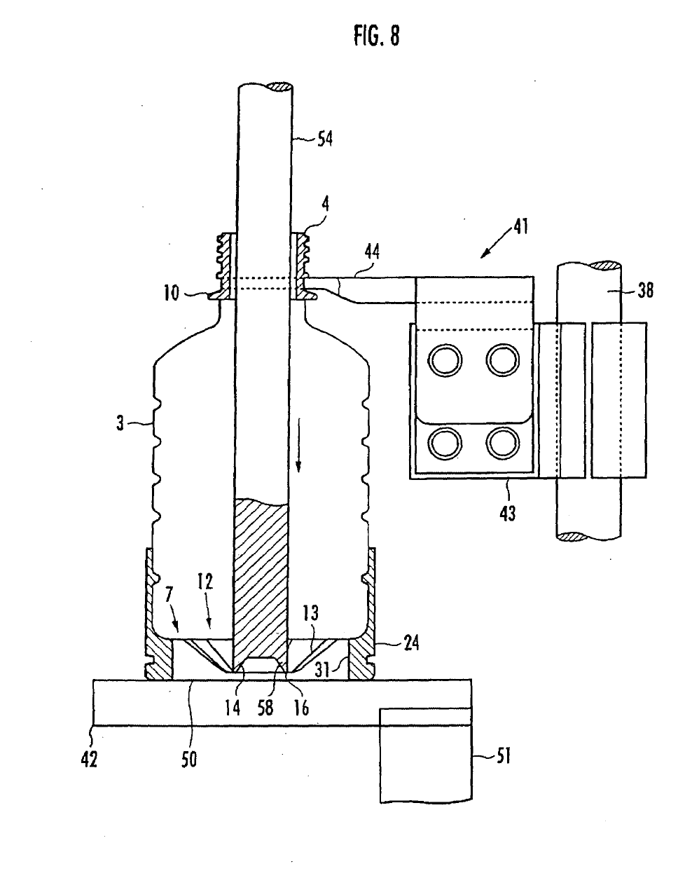

As shown in FIG. 7, the empty bottle chuck 41 comprises a base block 43, which is fixedly supported on the guide rods 38, and a pair of claw members 44, which are openably and closably supported on the base block 43. Further, a pinion gear 45 is disposed on an outer side of the base block 43 of the empty bottle chuck 41, wherein the pinion gear 45, as shown in FIG. 6, meshes with a rack 46, which is disposed for displacement up and down along the guide rod 38. As shown in FIG. 7, the pinion gear 45 drives an unillustrated opening/closing mechanism contained internally within the base block 43 through an axis of rotation 47. Moreover, the pinion gear 45 is rotated in response to raising and lowering of the rack 46, and in accordance therewith, the claw members 44 are opened and closed. As shown in FIG. 6, the rack 46 is equipped with a cam follower 48, such that the cam follower 48 is guided by a cam rail 49 disposed on an outer circumference of the support pillar 34, thereby raising and lowering the rack 46. As shown in FIG. 8, the claw members 44 of the empty bottle chuck 41 grip the opening 4 from the outside along an upper surface of the flange 10 of the empty bottle 3.

As shown in FIGS. 6 and 8, the empty bottle support table 42 comprises an auxiliary tool loader 50 for loading the auxiliary tool 24, which is injected from the auxiliary tool injection turret 19, and a raising/lowering arm 51, which is supported for being raised and lowered on the guide rod 38. As shown in FIG. 6, the raising/lowering arm 51 is equipped with a cam follower 52, such that the cam follower 52 is guided by a cam rail 53 disposed on an outer circumference of the support pillar 34, thereby raising and lowering the auxiliary tool loader 50. The cam follower 52 and the cam rail 53 constitute the table raising/lowering means of the present invention.

The empty bottle support table 42 installs the auxiliary tool 24, which is loaded onto the auxiliary tool loader 50, onto an empty bottle 3 by raising it along the bottom part 7 of the empty bottle 3, which is supported by the empty bottle chuck 41. At this time, because the empty bottle chuck 41 grips the opening 4 by the claw members 44 along an upper surface of the flange 10 of the empty bottle 3, even if an upward pressing force is applied to the empty bottle 3 when the auxiliary tool 24 is installed thereon, upward movement of the empty bottle 3 is reliably regulated. In addition, as shown in FIG. 8, the empty bottle 3 with the auxiliary tool 24 mounted thereon assumes a state of being sandwiched from above and below by the empty bottle chuck 41 and the empty bottle support table 42, and therefore the positional state of the empty bottle 3 is maintained.

As shown in FIG. 6, the bottom part projecting means 40 comprises a rod-shaped pushdown member 54, and a raising/lowering arm 55 connected to an upper end of the pushdown member 54, and which extends outside of the empty bottle 3 from an upper end of the pushdown member 54. The raising/lowering arm 55 is supported for being raised and lowered on the guide rod 38 and is equipped with a cam follower 56. The cam follower 56 is guided by a cam rail 57 disposed on an outer circumference of the support pillar 34, thereby raising and lowering the pushdown member 54. The cam follower 56 and the cam rail 57 constitute the pushdown member raising/lowering means of the present invention. As shown in FIG. 8, the pushdown member 54 is lowered from the opening 4 into the body part 6 and pushes down on the inversion part 12. The end of the pushdown member 54 is formed with a shape corresponding to the inward projecting portion 14 of the inversion part 12, and thereby, an annular protrusion 58 also is formed that pushes down along an inner circumferential edge (second hinge section 16.) of the inclined portion 13.

When the inversion part 12 of the empty bottle 3 is pushed down by the pushdown member 54, because the empty bottle 3 is placed in a positional state by being sandwiched between the empty bottle chuck 41 and the empty bottle support table 42, the annular protrusion 58 of the pushdown member 54 abuts with good precision against the inner circumferential edge (second hinge section 16) of the inclined portion 13. In addition, as a result of the auxiliary tool 24 being mounted on the empty bottle 3, the inversion part 12 of the empty bottle 3, which is pressed down and projected downwardly by the pushdown member 54, is accommodated within the opening 31 of the auxiliary tool, whereby the downward projection of the inversion part 12 can be smoothly carried out.

Next, an explanation shall be given concerning the filled bottle processing apparatus 2. As shown in FIG. 2, the filled bottle processing apparatus 2 is equipped with a bottom part recessing means 59, and an auxiliary tool separating means 61, which is disposed on a downstream side of the bottom part recessing means 59 via a filled bottle transport turret 60. A filled bottle injection turret 62 is disposed on an upstream side of the bottom part recessing means 59. The filled bottle injection turret 62 is connected to a terminal end of a filled bottle injection conduit 64, which is provided with a screw conveyor 63 therein, where after passing through an unillustrated filler and capper, the transported filled bottle 3 is input to the bottom part recessing means 59. Further, on a downstream side from the auxiliary tool separating means 61, a filled bottle discharge turret 65 and first and second auxiliary tool discharge turrets 66, 67 are provided. A filled bottle discharge conveyor 68 is connected to an initial end of the filled bottle discharge turret 65, and an auxiliary tool discharge conveyor 69 is connected to an initial end of the second auxiliary tool discharge turret 67.

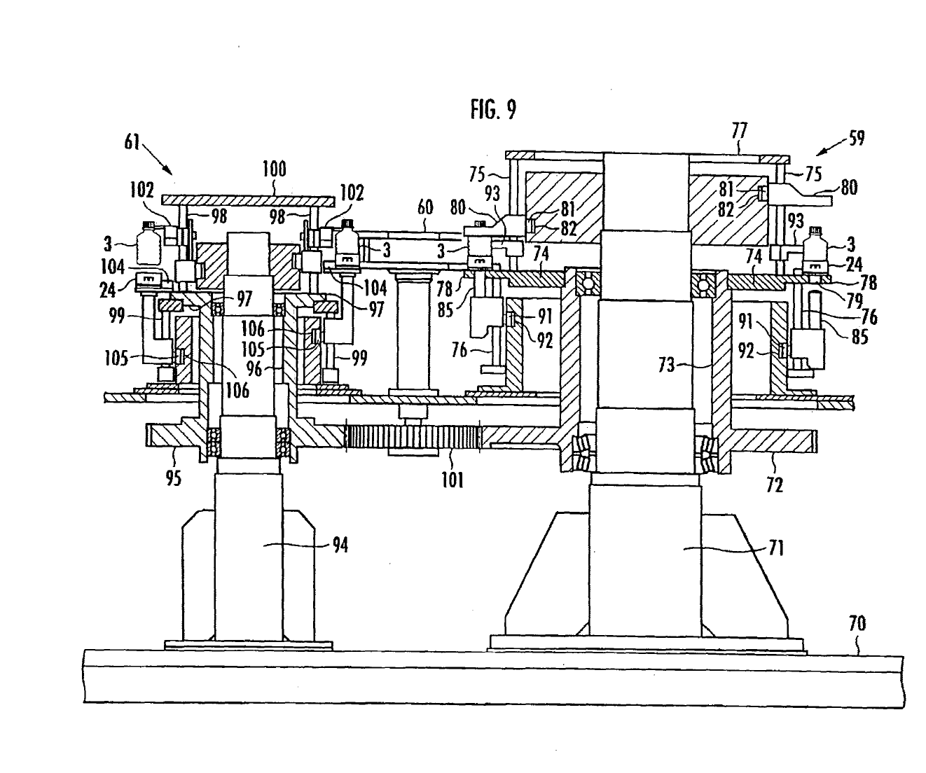

As shown in FIG. 9, the bottom part recessing means 59 comprises a support pillar 71 disposed in an upstanding manner on a base 70, a drive gear 72, which is supported rotatably on the support pillar 70, and an outer tubular support body 73 that rotates integrally with the gear 72. A filled bottle support table 74 is disposed integrally on the outer tubular support body 73. A plurality of first guide rods 75, which extend upwardly therefrom, and a plurality of second guide rods 76, which extend downwardly therefrom, are disposed on the filled bottle support table 74. A top panel 37 is supported integrally on upper ends of the first guide rods 75. The gear 72 is connected to an unillustrated rotary driving means such as a motor or the like.

The filled bottle support table 74 includes a plurality of filled bottle loading sections 78, wherein openings 79 are formed in the filled bottle loading sections 78, which penetrate vertically therethrough corresponding to the inversion parts 12 of the filled bottles 3.

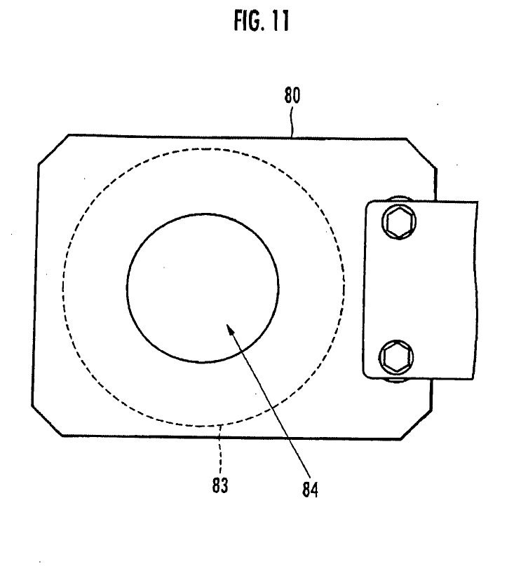

A shoulder presser 80 is supported while capable of being raised and lowered on the first guide rod 75. The shoulder presser 80 comprises a cam follower 81, such that the cam follower 81 is guided by a cam rail 82 disposed on an outer circumference of the support pillar 71, thereby raising and lowering the shoulder presser 80. As shown in FIG. 10, the shoulder presser 80 comprises a pressing recess therein corresponding in shape to the shoulder part 5 of the filled bottle 3, and as shown in plan view in FIG. 11, also includes an insertion hole 84, through which the opening 4 of the filled bottle 3 onto which the cap 8 has been fitted may be inserted.

As shown in FIG. 9, a pushup member 85 is supported while capable of being raised and lowered on the second guide rod 76. The pushup member 85, as shown in FIG. 10, is connected to an upper end of a raising/lowering shaft 86, wherein the raising/lowering shaft 86 is supported in a guide tube 87 so as to be capable of being raised and lowered through a shock absorbing spring 88. A pushup abutment member 89, having a shape corresponding to the inclined portion 13 and the inward projecting portion 14 of the inversion part 12, is formed at the tip end of the pushup member 85. The guide tube 87 is connected to a slide block 90, which is slidably supported on the second guide rod 76. The slide block 90 is equipped with a cam follower 91, wherein the cam follower 91 is guided by a cam rail 92 disposed with a given gap circumferentially around the support pillar 71. The cam follower 91 and the cam rail 92 constitute the punch raising/lowering means of the present invention. Further, in the present embodiment, the shape of the pushup abutment member 89 is shown as corresponding to the inclined portion 13 and the inward projecting portion 14 of the inversion part 12. However, although not shown, for example, concerning the abutting part that abuts against the inclined portion 13 (i.e., the circumferential region around the part that corresponds to the inward projecting portion 14), the shape thereof may also be formed so as to abut in a circumferential form on a portion of the inclined portion 13.

The pushup member 85 is positioned downwardly of each of the filled bottle loading sections 78 of the filled bottle support table 74, so that when the support pillar 71 is rotated around, the pushup member 85 is raised to penetrate through the openings 79 of the filled bottle loading sections 78 under the guidance of the cam rail 92. Owing thereto, the end of the pushup member 85 presses up on the downwardly projecting inversion part 12 of the filled bottle 3, causing the inversion part 12 to become recessed inwardly into the filled bottle 3. At this time, by providing the shock absorbing spring 88 in the interior of the guide tube 87, an excessive pushing force from the pushup member 85 is prevented from being imposed on the inversion part 12, whereby damage to the inversion part 12 can reliably be prevented. Further, by providing the pushup abutment member 89 on the end of the pushup member 85, the inversion part 12 can be recessed along the recessed shape thereof when the inversion part is inwardly recessed, and inadvertent deformations of the bottom part 7 can be prevented, enabling the inversion part to be smoothly recessed inwardly. In FIGS. 9 and 10, reference numeral 93 indicates a holder that supports the bottle 1 from one side thereof.

As shown in FIG. 9, the auxiliary tool separating means 61 is equipped with a support pillar 94 that stands upright on a base 70, a drive gear 95, which is supported rotatably by the support pillar 94, and an outer tubular support body 96 that rotates integrally with the drive gear 95. On the upper end outside periphery of the outer tubular support body 96, a flange-shaped projecting portion 97 is provided, wherein a plurality of upwardly extending first guide rods 98 and a plurality of downwardly extending second guide rods 99 are provided on the projecting portion 97. A top panel 100 is supported integrally on upper ends of the first guide rods 98. The gear 95 is arranged to rotate simultaneously with the gear 72 of the aforementioned bottom part recessing means 59 through a drive gear 101 of the filled bottle transport turret 60.

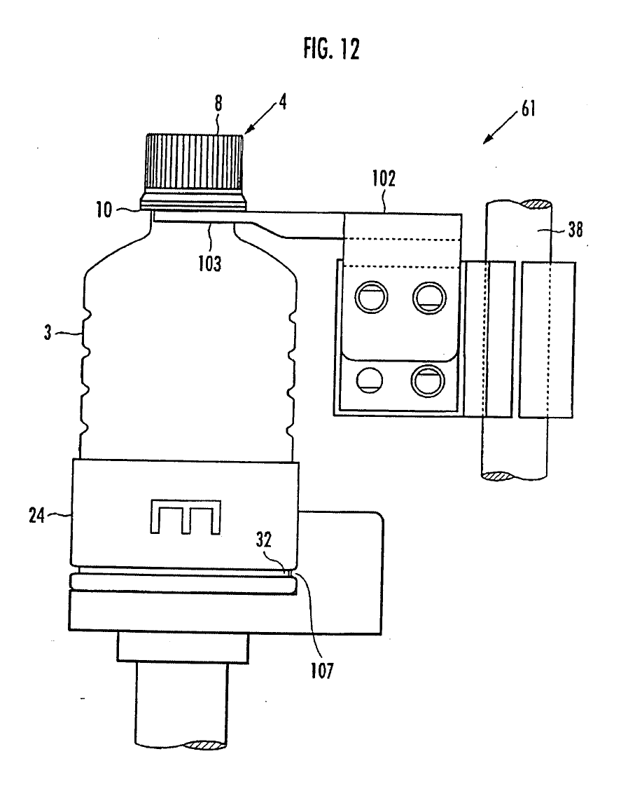

A filled bottle chuck 102 is supported in a fixed condition to the first guide rod 98. The filled bottle chuck 102 has a similar structure as that of the previously discussed empty bottle chuck 41, and therefore detailed explanations thereof shall be omitted. However, differing from the empty bottle chuck 41, as shown in FIG. 12, a pair of claw members 103, which open and close, grip the opening 4 on which the cap 8 is fitted from an outer side thereof along a lower surface of the flange 10 of the filled bottle 3.

As shown in FIG. 9, an auxiliary tool connection member 104 is supported so as to enable raising and lowering thereof on the second guide rod 99. The auxiliary tool connection member 104 is equipped with a cam follower 105, wherein the cam follower 105 is guided by a cam rail 106 disposed with a given gap circumferentially around the support pillar 94. The cam follower 105 and the cam rail 106 constitute the connection member raising/lowering means of the present invention. As shown in FIG. 12, the auxiliary tool connection member 104 includes a projection 107 for engagement in an engagement groove 32, which is formed on the outer circumferential surface of the auxiliary tool 24. The auxiliary tool connection member 104 is raised along the auxiliary tool 24, whereby the projection 107 is made to engage in the engagement groove 32, and while the engagement state is maintained, the auxiliary tool 24 is separated from the filled bottle 3 by lowering the auxiliary tool connection member 104. Then, as shown in FIG. 2, the mutually separated filled bottle 3 and the auxiliary tool 24 are transferred respectively to the filled bottle discharge turret 65 and the first auxiliary tool discharge turret 66, whereby they are discharged.

The content filled bottle is manufactured in the following manner by the device of the present embodiment, which is constructed as described above. More specifically, first, the auxiliary tool 24 is installed onto the bottom part 7 of an empty bottle 3 by the auxiliary tool mounting means 39 of the empty bottle processing apparatus 1 shown in FIGS. 1 and 6 (auxiliary tool mounting step). Next, as shown in FIG. 8, the inversion part 12 on the bottom part 7 of the empty bottle 3, on which the auxiliary tool 24 has been mounted, is pressed downwardly and inverted by the bottom part projecting means 40 of the empty bottle processing apparatus 1. Then, although not shown, the interior of the bottle 3 for which the inversion part 12 thereof has been inverted and projected downward is filled with liquid contents by a filler (content filling step), and a cap 8 is fitted to and seals the opening 4 of the filled bottle 3, the interior of which has been filled with liquid contents, by a capper (sealing step). Thereafter, as shown in FIG. 10, the inversion part 12 that projects downwardly from the filled bottle 3 is pressed upward and recessed inwardly into the bottle by the bottom part recessing means 59 of the filled bottle processing apparatus 2 shown in FIGS. 2 and 9 (bottom part recessing step). Additionally, the auxiliary tool 24 is separated from the filled bottle 3 for which the inversion part 12 thereof has been recessed by the auxiliary tool separating means 61 of the filled bottle processing apparatus 2 shown in FIG. 12 (auxiliary tool separating step).

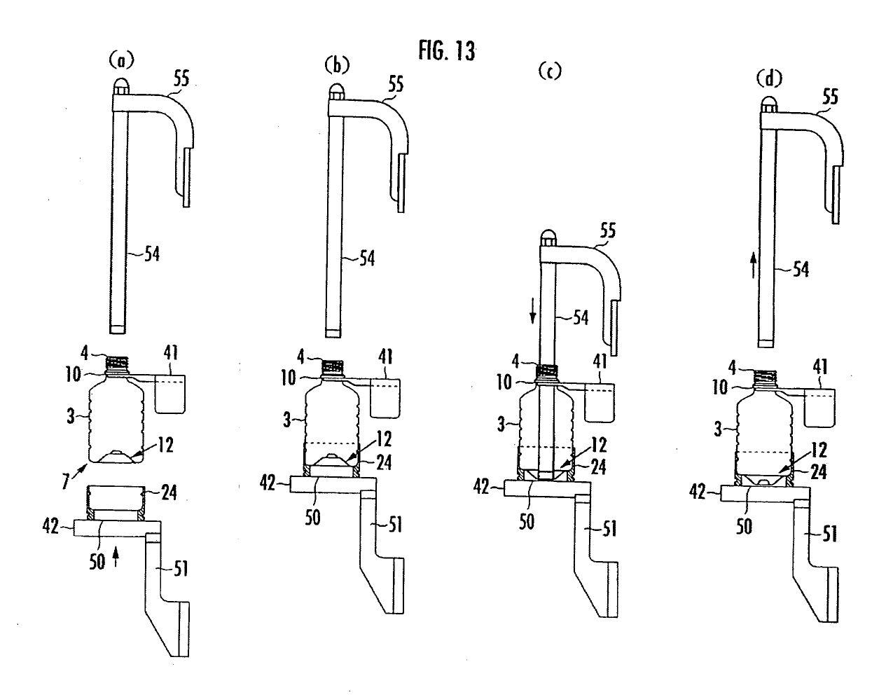

As shown in FIG. 13(a), in the auxiliary tool mounting means 39, the opening 4 is gripped from the outside by the empty bottle chuck 41 along an upper surface of the flange 10 of the empty bottle 3 (empty bottle retaining step). Next, as shown in FIG. 13(b), the empty bottle support table 42 on which the auxiliary tool 24 is mounted is raised, whereby the auxiliary tool 24 is installed onto the bottom part 7 of the empty bottle 3. At this time, the empty bottle 3 is loaded onto the empty bottle support table 42 through the auxiliary tool 24, and the empty bottle 3 is sandwiched and held between the empty bottle chuck 41 and the empty bottle support table 42, thereby securing the empty bottle 3 in a properly positioned state (empty bottle loading step).

Next, in the bottom part projecting means 40, as shown in FIG. 13(c), the pushdown member 54 is lowered from the opening of the empty bottle 3, which is loaded on the empty bottle support table 42, and the inversion part 12 is pressed down from an inner side of the empty bottle 3 by the end of the pushdown member 54, thereby causing the inversion part 12 to become inverted and project outwardly (bottom part downward pressing step). At this time, as shown in FIG. 8, by providing the annular protrusion 58 on the end of the pushdown member 54, the annular protrusion 58 abuts against the second hinge section 16 at the inner circumferential edge of the inclined portion 13, so that the inversion part 12 can be inverted smoothly. Moreover, because the empty bottle 3 is sandwiched and positioned between the empty bottle chuck 41 and the empty bottle support table 42, the annular protrusion 58 of the pushdown member 54 can be made to abut with good accuracy against the second hinge section 16.

Additionally, as shown in FIG. 13(d), after the inversion part 12 has been inverted to project outwardly, the pushdown member 54 is raised and retracted from the interior of the empty bottle 3 (pushdown member retracting step), the empty bottle 3 is released from being retained by the empty bottle chuck 41, and the empty bottle 3 is transferred to the discharge turret 25 shown in FIG. 1 and discharged therefrom. The interior of the discharged empty bottle 3 is filled with liquid contents, the filled bottle is sealed by a cap, and the bottle is input to the filled bottle processing apparatus 2.

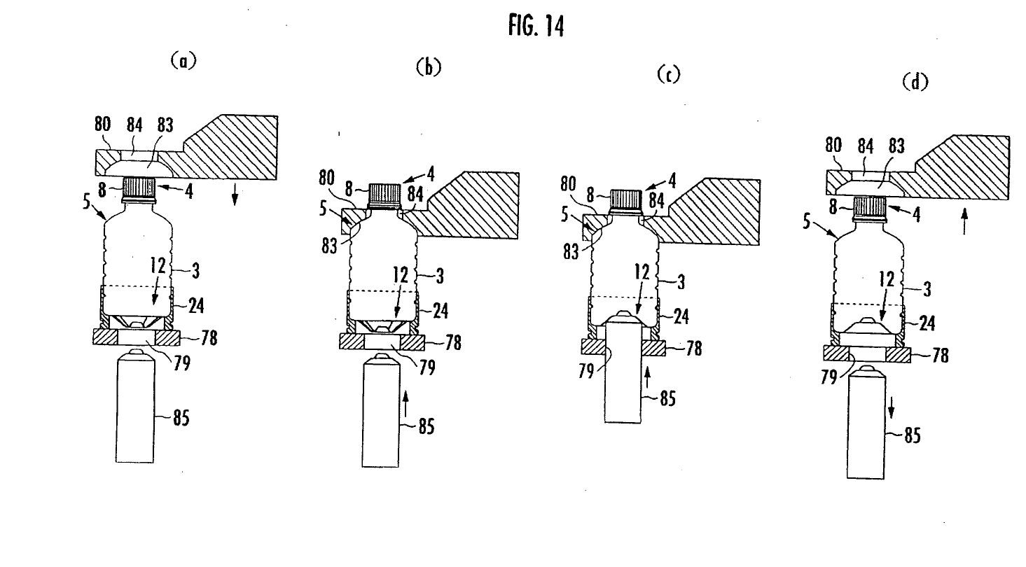

In the bottom part recessing means 59 of the filled bottle processing apparatus 2, first, as shown in FIG. 14(a), the filled bottle 3 is loaded onto the filled bottle support table 74 (filled bottle loading step). Next, as shown in FIG. 14(b), the shoulder presser 80 is lowered, whereby the shoulder part 5 of the filled bottle 3, which has been loaded onto the filled bottle support table 74, is pressed from above (shoulder part pressing step). Owing thereto, the filled bottle 3 is placed in a positioned state wherein upward movement thereof is prohibited. Further, while this positioned state is maintained, as shown in FIG. 14(c), the pushup member 85 is raised, thereby pressing upwardly on the inversion part 12 of the filled bottle 3, which is in an outwardly projected state, and causing the inversion part to be recessed inwardly by the end of the pushup member 85 (bottom part pushup step). At this time, as shown in FIG. 10, because the pushup abutment member 89 of the pushup member 85 causes the inversion part 12 to be recessed inwardly along an inwardly inverted shape, inadvertent deformation of the bottom part is reliably prevented, and the inversion part 12 can be smoothly recessed inwardly. Moreover, by proper positioning of the filled bottle 3 by the shoulder presser 80, the pushup abutment member 89 of the pushup member 85 is made to abut against the inclined portion 13 and the inward projecting portion 14 of the inversion part 12, so that the inversion part 12 can be recessed reliably. Thereafter, as shown in FIG. 14(d), the pushup member 85 is lowered downward from the filled bottle support table 74, the shoulder presser 80 is raised, and as shown in FIG. 2, the filled bottle 3 is transferred to the filled bottle transport turret 60. The filled bottle transport turret 60 delivers the filled bottle 3 to the auxiliary tool separating means 61.

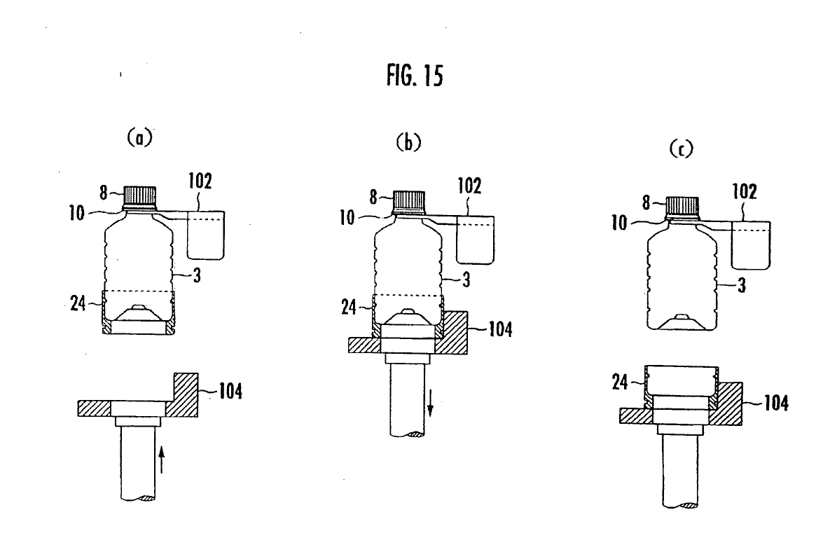

In the auxiliary tool separating means 61 of the filled bottle processing apparatus 2, the filled bottle 3, which has been delivered from the filled bottle transport turret 60, is retained by the filled bottle chuck 102 as shown in FIG. 15(a). At this time, the filled bottle chuck 102 grips the opening 4 from the outside along an upper surface of the flange 10 of the filled bottle 3 (filled bottle retaining step). Next, as shown in FIG. 15(b), the auxiliary tool connection member 104 is raised and made to connect with the auxiliary tool 24 mounted on the filled bottle 3. Additionally, as shown in FIG. 15(c), the auxiliary tool connection member 104 is lowered, thereby pulling the auxiliary tool 24, which is mounted on the filled bottle 3, downwardly and causing the auxiliary tool 24 to separate from the filled bottle 3 (auxiliary tool pull down step). Thereafter, as shown in FIG. 2, the auxiliary tool 24 is transferred to the first auxiliary tool discharge turret 66 and is discharged, the filled bottle 3 is released from being retained by the filled bottle chuck 102, and the filled bottle 3 is transferred to the filled bottle discharge turret 65 and discharged therefrom.

### INDUSTRIAL APPLICABILITY

In the manufacturing method and device for manufacturing a content filled bottle according to the present invention, an inversion part is provided on a bottom part of the bottle, wherein the bottle is manufactured by filling liquid contents into the interior of a synthetic resin bottle, and the inversion part thereof is capable of being inverted between a state in which the inversion part is recessed inwardly along an axial direction of the body part, and a state in which the inversion part projects outwardly from the body part. In accordance with such a manufacturing method and device for manufacturing a content filled bottle of the present invention, inappropriate deformation and buckling of the bottle can be prevented, thus enabling a content filled bottle to be manufactured with good efficiency and high product quality.

1. A method for manufacturing a content-filled bottle, in which liquid contents are hermetically sealed in a synthetic resin bottle comprising a hollowed body part, an opening provided on an upper end of said body part and capable of being fitted with a cap thereon, a bottom part that closes a bottom end of said body part, and an inversion part provided within a portion of said bottom part, which is capable of undergoing inversion between a state of being recessed inwardly into said body part along an axial direction of said body part, and a state of projecting outwardly from said body part, the method comprising:
an auxiliary tool mounting step by which a cylindrical auxiliary tool capable of being mounted on the bottom part of said bottle, formed with a shape such that a portion corresponding to said inversion part is opened so as to be capable of accommodating said inversion part in a state of projecting outwardly from the body part, is mounted onto a bottom part outer periphery of a non-content-filled empty bottle under a condition in which the inversion part is recessed inwardly into said body part;
a bottom part projecting step in which the inversion part on the bottom part of the empty bottle, on which the auxiliary tool has been mounted by said auxiliary tool mounting step, is made to project outwardly from the body part;
a content filling step in which liquid contents are filled into the interior of the bottle having the inversion part thereof projecting outwardly from the body part by means of said bottom part projecting step;
a sealing step in which a cap is fitted onto said opening of the filled bottle, the interior of which has been filled with liquid contents by said content filling step, for sealing said bottle;
a bottom part recessing step by which the inversion part that projects outwardly from the filled bottle on which the cap has been fitted by said sealing step is recessed inwardly into said body part; and
an auxiliary tool separating step in which said auxiliary tool is separated from the filled bottle in which the inversion part has become recessed inwardly into said body part by said bottom part recessing step,
wherein said auxiliary tool mounting step further comprises an empty bottle retaining step for retaining the empty bottle by gripping said opening from an outer side thereof along an upper surface of a flange that is formed on an outer periphery of the opening of the empty bottle, and an empty bottle loading step in which an empty bottle support table that raisably supports the empty bottle onto which the auxiliary tool has been mounted is raised, whereby the auxiliary tool is installed onto the bottom part of the empty bottle that is retained by said retaining step, and wherein said empty bottle is loaded onto said empty bottle support table through said auxiliary tool, and
wherein said bottom part projecting step further comprises a bottom part downward pressing step in which a rod shaped pushdown member is lowered in an axial direction from the opening of the empty bottle, which has been loaded onto the empty bottle support table by said empty bottle loading step, and is inserted into the interior of said empty bottle, whereby the inversion part in an inwardly recessed state is pressed downwardly by an end of said pushdown member from the inside of the empty bottle so as to project outwardly from the body part, and a pushdown member retracting step in which said pushdown member is raised and retracted from the inside of the empty bottle after the inversion part has been inversely projected by said bottom part downward pressing step.

2. The method for manufacturing a content-filled bottle according to claim 1, wherein when the inversion part of said synthetic resin bottle comprises an inclined portion, which is capable of concave/convex inversion in a symmetrical shape inwardly and/or outwardly of the body part, and a bottom part central portion formed in a region surrounded by said inclined portion, in the bottom part downward pressing step of said bottom part projecting step, the inversion part is pressed downward by the end of said pushdown member along at least an inner peripheral edge of the inclined portion of said inversion part.

3. The method for manufacturing a content-filled bottle according to claim 1, wherein in said bottom part downward pressing step and in said pushdown member retracting step, raising and lowering of said pushdown member is driven through an arm that extends outwardly of said bottle along a vertical direction of the bottle, and which is connected to an upper end of said pushdown member.

4. The method for manufacturing a content-filled bottle according to claim 1, wherein said bottom part recessing step further comprises:
a filled bottle loading step by which said filled bottle on which said auxiliary tool is installed is loaded onto a filled bottle support table on which a downward position corresponding to said inversion part is open;
a shoulder part pressing step by which a shoulder part, which extends to an upper end of the body part from a lower end of an opening of the filled bottle that is loaded onto the filled bottle support table, is pressed so as to prevent upward movement thereof; and
a bottom part pushup step in which said inversion part, in a state of projecting outwardly from the body part of the filled bottle, which is prevented from upward movement by said shoulder part pressing step, is pressed upwardly and recessed into said body part by an end of a rod shaped pushup member.

5. The method for manufacturing a content-filled bottle according to claim 4, wherein when the inversion part of said synthetic resin bottle comprises an inclined portion, which is capable of concave/convex inversion in a symmetrical shape inwardly and/or outwardly of the body part, and a bottom part central portion formed in a region surrounded by said inclined portion, in the bottom part pushup step of said bottom part recessing step, the inclined portion and the bottom part central portion of said inversion part are pressed upwardly by the end of said pushup member.

6. The method for manufacturing a content-filled bottle according to claim 1, wherein said auxiliary tool separating step further comprises:
a filled bottle retaining step in which said opening is gripped from the outside along a lower surface of a flange formed on an outer periphery of the opening of the filled bottle; and
an auxiliary tool pull down step of coupling to said auxiliary tool, which is installed on the filled bottle retained by said filled bottle retaining step, and pulling said auxiliary tool downward of the filled bottle.

7. A device for manufacturing a content-filled bottle, in which liquid contents are hermetically sealed in a synthetic resin bottle comprising a hollowed body part, an opening provided on an upper end of said body part and capable of being fitted with a cap thereon, a bottom part that closes a bottom end of said body part, and an inversion part provided within a portion of said bottom part, which is capable of undergoing inversion between a state of being recessed inwardly into said body part along an axial direction of said body part, and a state of projecting outwardly from said body part, the device comprising:
auxiliary tool mounting means for mounting a cylindrical auxiliary tool capable of being mounted on the bottom part of said bottle, formed with a shape such that a portion corresponding to said inversion part is opened so as to be capable of accommodating said inversion part in the state of projecting outwardly from the body part, onto a bottom part outer periphery of a non-content-filled empty bottle under a condition in which the inversion part is recessed inwardly into said body part;
bottom part projecting means for causing the inversion part on the bottom part of the empty bottle, on which the auxiliary tool has been mounted by said auxiliary tool mounting means, to project outwardly from the body part;
content filling means for filling liquid contents into the interior of the bottle having the inversion part thereof projected outwardly from the body part by means of said bottom part projecting means;
sealing means for fitting a cap on said opening of the filled bottle, the interior of which has been filled with liquid contents by said content filling means, for thereby sealing said bottle;
bottom part recessing means for recessing the inversion part, which projects outwardly from the filled bottle on which the cap has been fitted by said sealing means, inwardly into said body part; and
auxiliary tool separating means for separating said auxiliary tool from the filled bottle in which the inversion part has been recessed inwardly into said body part by said bottom part recessing means,
wherein said auxiliary tool mounting means further comprises an empty bottle chuck for gripping said opening from an outer side thereof along an upper surface of a flange that is formed on an outer periphery of the opening of the empty bottle, an empty bottle support table disposed below the empty bottle that is retained by said empty bottle chuck, which is raised with said auxiliary tool loaded thereon whereby the auxiliary tool is installed onto the bottom part of the empty bottle, and which supports the empty bottle for raising and lowering through said auxiliary tool, and table raising/lowering means for driving raising and lowering of said empty bottle support table, and
wherein said bottom part projecting means further comprises a rod shaped pushdown member, which is capable of being raised and lowered, disposed above an opening of the empty bottle that is retained by said empty bottle chuck, and which is inserted into the interior of said empty bottle from said opening, whereby the inversion part in an inwardly recessed state is pressed downwardly from the inside of the empty bottle so as to project outwardly from the body part, and a pushdown member raising/lowering means for driving raising and lowering of said pushdown member.

8. The device for manufacturing a content-filled bottle according to claim 7, wherein when the inversion part of said synthetic resin bottle comprises an inclined portion, which is capable of concave/convex inversion in a symmetrical shape inwardly and/or outwardly of the body part, and a bottom part central portion formed in a region surrounded by said inclined portion, the pushdown member of said bottom part pushdown means comprises an annular protrusion on an end thereof, which presses downward along at least an inner peripheral edge of the inclined portion of said inversion part.

9. The device for manufacturing a content-filled bottle according to claim 7, wherein said pushdown member raising/lowering means is positioned on an upper side of the empty bottle that is retained by said empty bottle chuck, and is connected to said pushdown member through an arm extending directly above the opening of said empty bottle.

10. The device for manufacturing a content-filled bottle according to claim 7, wherein said bottom part recessing means further comprises:
a filled bottle support table having an opening therein open at a downward position corresponding to said inversion part of said filled bottle on which said auxiliary tool is mounted;
a shoulder part presser by which a shoulder part, which extends to an upper end of the body part from a lower end of an opening of the filled bottle that is loaded onto the filled bottle support table, is pressed so as to prevent upward movement thereof;
a rod shaped pushup member, which is capable of being raised and lowered, and by which said inversion part, in a projected state, is pressed upwardly and recessed into said body part through the opening of said filled bottle support table by an end of the rod shaped pushup member; and
a punch raising/lowering means for raising and lowering said pushup member.

11. The device for manufacturing a content-filled bottle according to claim 10, wherein when the inversion part of said synthetic resin bottle comprises an inclined portion, which is capable of concave/convex inversion in a symmetrical shape inwardly and/or outwardly of the body part, and a bottom part central portion formed in a region surrounded by said inclined portion is provided, the pushup member of said bottom part recessing means comprises a pushup abutment part on an end thereof which abuts against said inversion part, and
wherein said pushup abutment part has a shape corresponding to said bottom part central portion, and also has a shape adapted to circumferentially press at least a part of said inclined portion.

12. The device for manufacturing a content-filled bottle according to claim 7, wherein said auxiliary tool separating means further comprises:
a filled bottle chuck for gripping said opening from an outer side thereof along a lower surface of the flange formed on the outer periphery of the opening of the filled bottle;
an auxiliary tool coupling member, which is capable of being raised and lowered so as to be coupled to said auxiliary tool that is mounted on the filled bottle retained by said filled bottle chuck, and for pulling down said auxiliary tool downward of said filled bottle, so as to separate said auxiliary tool from the filled bottle; and
coupling member raising and lowering means for driving raising and lowering said auxiliary tool coupling member.

13. The device for manufacturing a content-filled bottle according to claim 12, wherein said auxiliary tool comprises an annular latching groove on an outer peripheral surface thereof, and
said auxiliary tool coupling member includes a projection that engages with said latching groove of the auxiliary tool, said projection latching with said latching groove when the auxiliary tool is raised by said coupling member raising and lowering means, and the latched state between the projection and the latching groove being maintained when said coupling member raising and lowering means is lowered, thereby separating the auxiliary tool from the filled bottle.

14. The device for manufacturing a content-filled bottle according to claim 7, wherein said auxiliary tool comprises engaging pawls on a circumferential wall thereof, which are elastically attachable/detachable with a recess formed in the body part of the bottle.
